(19) United States
(12) Patent Application Publication
(10) Pub. No.: US 2015/0321217 A1
(43) Pub. Date: Nov. 12, 2015

(54) SOLID STATE METAL POWDER CONSOLIDATION FOR STRUCTURAL COMPONENTS

(71) Applicant: UNITED TECHNOLOGIES CORPORATION, Hartford, CT (US)

(72) Inventors: Aaron T. Nardi, East Granby, CT (US); Tahany I. El-Wardany, Bloomfield, CT (US); Daniel V. Viens, Mansfield Center, CT (US)

(21) Appl. No.: 14/763,915

(22) PCT Filed: Jan. 28, 2013
(86) PCT No.: PCT/US13/23432

§ 371 Date: Jul. 28, 2015

(51) Int. Cl. B05D 1/12; C23C 24/04; B05B 7/14; C23C 26/00

(52) U.S. Cl. CPC B05D 1/12; C23C 26/00; C23C 24/04; B05B 7/14

(57) ABSTRACT

An additive manufacturing system includes a cold spray system operable to accelerate a powdered material. In one embodiment, wherein the powdered material includes a ductile material. In the alternative or additionally thereto, the foregoing embodiment, includes wherein the powdered material is a copper alloy. In the alternative or additionally thereto, the foregoing embodiment includes, wherein the powdered material is an aluminum alloy.

### BACKGROUND

The present disclosure relates generally to powder additive manufacturing applications.

Powder metallurgy is often utilized to produce near net shape parts at relatively high production rates and relatively low cost. Generally, sintering is utilized for consolidation of the material with post processing to improve the mechanical properties of the resultant components.

Sintering may provide a structure with relatively high porosity. Also, oxides in the powder and relatively low levels of work in the material may allow defects to be present which may or may not be eliminated in follow-on processes. These potential defects are at least partially overcome through significant working of the material through extrusion, rolling or other conventional processes. This allows the use of powdered materials that may not be readily produced by Ingot metallurgy in structural applications, but eliminates the advantageous potential for near net shape formation.

### SUMMARY

An additive manufacturing system according to one disclosed non-limiting embodiment of the present disclosure includes a cold spray system operable to accelerate a powdered material.

In a further embodiment of any of the foregoing embodiments, wherein the powdered material includes a ductile material. In the alternative or additionally thereto, the foregoing embodiment, includes wherein the powdered material is a copper alloy. In the alternative or additionally thereto, the foregoing embodiment includes, wherein the powdered material is an aluminum alloy.

In a further embodiment of any of the foregoing embodiments, wherein the powdered material includes one or more of a titanium alloy, magnesium alloy cobalt alloy, carbide, nitride and oxide.

In a further embodiment of any of the foregoing embodiments, the powdered material is particles of approximately 1-100 μm.

In a further embodiment of any of the foregoing embodiments, the cold spray system utilizes a carrier gas at a velocity of approximately 300-1500 m/s.

In a further embodiment of any of the foregoing embodiments, the cold spray system utilizes a carrier gas, the carrier gas is an inert gas.

In a further embodiment of any of the foregoing embodiments, the cold spray system utilizes a carrier gas, the carrier gas is a semi-inert gas.

In a further embodiment of any of the foregoing embodiments, the cold spray system utilizes a carrier gas, the carrier gas is non-oxidizing to powdered material particles.

In a further embodiment of any of the foregoing embodiments, the cold spray system utilizes a carrier gas, the carrier gas is non-oxidizing to powdered material particles.

In a further embodiment of any of the foregoing embodiments, the cold spray system utilizes a carrier gas at temperatures of approximately 1470 F (800 C).

In a further embodiment of any of the foregoing embodiments, the cold spray system utilizes a carrier gas, the carrier gas is Helium.

In a further embodiment of any of the foregoing embodiments, the cold spray system utilizes a carrier gas, the carrier gas is Nitrogen.

In a further embodiment of any of the foregoing embodiments, the cold spray system utilizes a carrier gas, the carrier gas is Krypton.

A method of additive manufacturing according to one disclosed non-limiting embodiment of the present disclosure includes cold spraying a powdered material to accelerate and plastically deform the powdered material to form a near net shape component.

In a further embodiment of any of the foregoing embodiments, the method includes cold spraying the powdered material onto a substrate.

In a further embodiment of any of the foregoing embodiments, the method includes generating high strain rate plasticity.

In a further embodiment of any of the foregoing embodiments, the method includes cold spraying the powdered material via a cold spray system.

In a further embodiment of any of the foregoing embodiments, the method includes cold spraying a multiple of powdered materials to form the near net shape component.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a general schematic view of an exemplary cold spray system;

FIG. 2 is an comparison between a cold sprayed additive manufacturing component and an equivalent conventional wrought component;

FIG. 3 is a partial sectional view of a cold sprayed additive manufacturing component;

FIG. 4 is a flow diagram of a method of repairing an actively cooled component according to one disclosed non-liming embodiment;

FIG. 5 is a partial sectional view of a cold sprayed additive manufacturing component optimized for light weight; and

FIG. 6 is a partial sectional view of a cold sprayed additive manufacturing component optimized for low cost.

### DETAILED DESCRIPTION

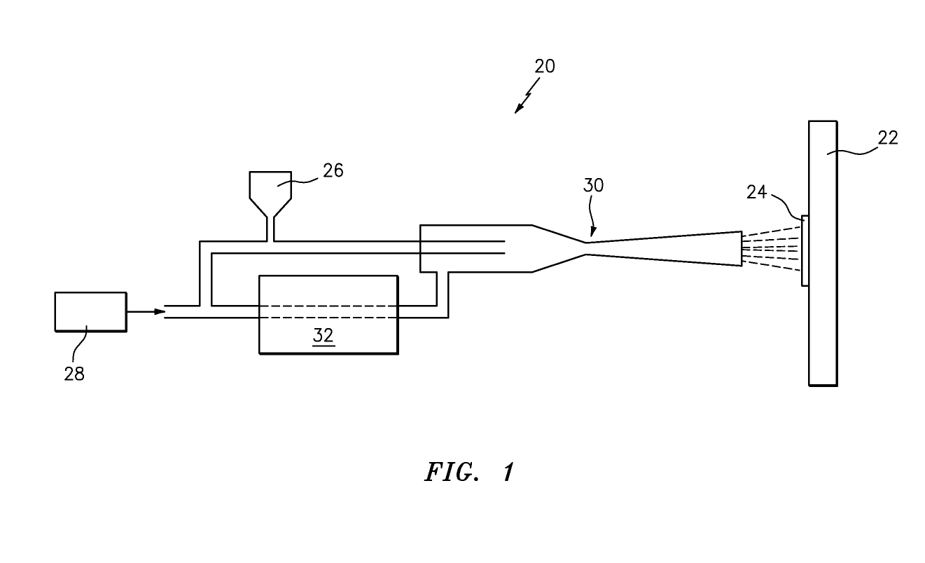

FIG. 1 schematically illustrates a cold spray system 20 that is utilized to produce dense powdered metal components that incorporate high levels of work into the process of densification. Cold gas-dynamic spraying (cold spray) may be utilized as an Additive Manufacturing (AM) process. Significantly higher strength through recrystallization and microstructure refinement is provided via the cold spray system 20 as other powder processes cannot produce the level of working and thus the mechanical properties of this process. One example cold spray system 20 is that manufactured by, for example, Sulzer Metco Kinetiks™ 4000 Cold Spray Gun.

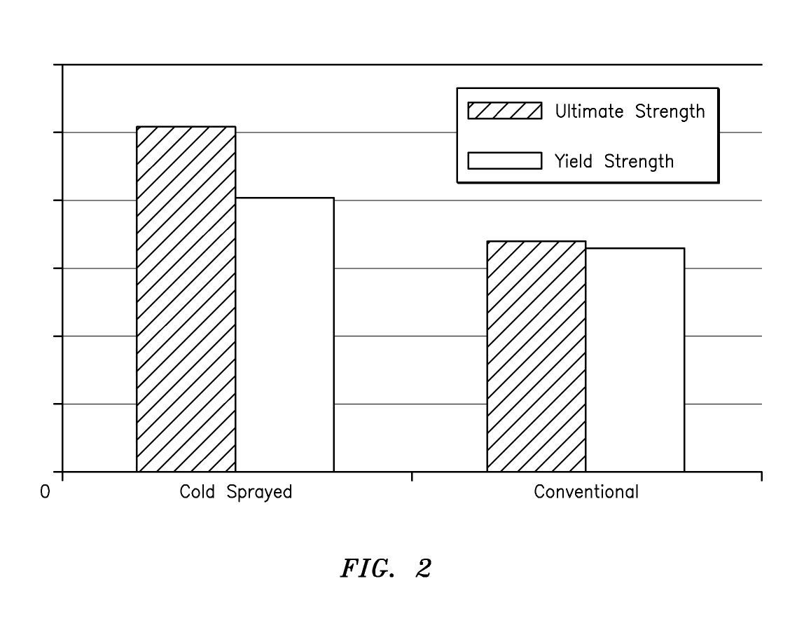

The cold spray system 20 exposes a metallic substrate 22 to a high velocity 671-3355 mph (300-1500 m/s) jet of relatively small 0.00004-0.0039 inches (1-100 μm) powdered metal particles accelerated by a supersonic jet of compressed gas. The cold spray system 20 accelerates the powdered metals toward the substrate such that the powdered metal particles deform on impact to generate high strain rate plasticity. This plasticity works the powdered metals, densifies the structure, and due to the high strain rate of the process, recrystallizes nano-grains in the deposited material. Experiments have shown that a component produced through this cold spray process may exhibits strength in excess of an equivalent wrought counterpart (FIG. 2).

The cold spray process disclosed herein selects the combination of particle temperature, velocity, and size that allows spraying at a temperature far below the melting point of the powdered metals which results in a layer 24 of particles in their solid state. The cold spray system 20 also offers significant advantages that minimize or eliminate the deleterious effects of high-temperature oxidation, evaporation, melting, crystallization, residual stresses, de-bonding, gas release, and other common problems of other additive manufacturing methods yet provides strong bond strength on coatings and substrates.

In one disclosed non-limiting embodiment, the powdered metal may include one or more various ductile metals 26 such as Copper, Aluminum, steel alloys or others that plastically deform. The prime mover of the cold spray system 20 is an inert or semi-inert carrier gas 28 such as Helium, Nitrogen or Krypton that is non-oxidizing to the powdered metal particles.

The velocity of the spray is inversely proportional to the molecular mass of the gas 28 such that a mixture of gasses may also be utilized to further control resultant temperatures and particle velocity. Generally, the desired velocity is great enough to break the oxide film on the powdered metal particles yet remain below the speed of sound through a convergent divergent nozzle 30. Furthermore, the temperature of the gas readily affects the velocity at which the speed of sound is reached. For example, a cold gas reaches the speed of sound at approximately 805 mph (360 m/s) while the same gas at approximately 1470 F (800 C) may be propelled at approximately 1118 mph (500 m/s). In one example, the carrier gas may be heated to temperatures of approximately 1470 F (800 C) with heater 32.

The cold spray system 20 may be used as an Additive Manufacturing process to produce higher strength, lighter weight and consolidated components such as gear and shaft components through the layered deposition of powdered metals. It should be understood that although particular component types are illustrated in the disclosed non-limiting embodiment, other components will also benefit herefrom.

The cold spray system 20 facilitates additive manufacturing through the deposition of powdered metals of multiple materials. The additive manufactured component may then be readily heat treated, and machined to final shape.

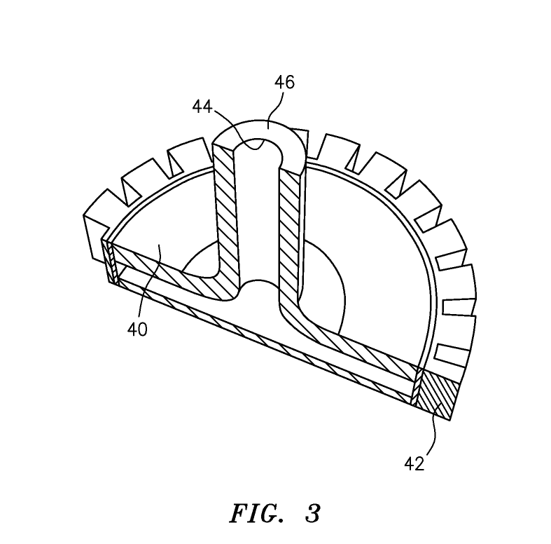

With reference to FIG. 3, in one disclosed non-limiting embodiment, two or more different powdered metals may be utilized. For example only, a core 40 of a gear or shaft may be manufactured with low carbon steel alloy powder to provide high bending fatigue resistance, while an outer surface 42 such as gear teeth may be manufactured with a tool steel alloy powder to provide high wear resistance and high surface hardness. The additive manufactured near net shape may then be heat treated and machined in its hardened state to a final profile.

An interface between the core 40 and the outer surface 42 need not be consistent. That is, the interface between the core 40 and the outer surface 42 may be delineated in response to expected loads, weight or other variables.

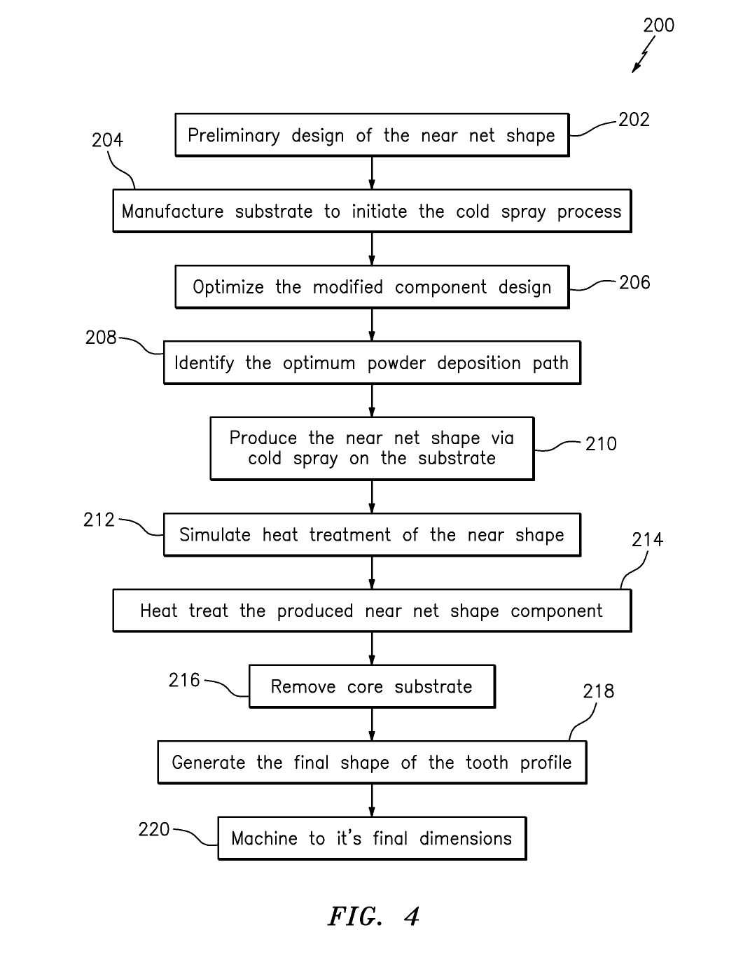

With reference to FIG. 4, a cold spray additive manufacture process 200 to additive manufacture a component is schematically illustrated. The additive manufacturing process constructs a component layer by layer from powdered metal. The powdered metal of each layer may be consolidated either by diffusion through melting via, for example, a laser or electron beam, or are bonded through plastic deformation of both substrate and powder metal particle layers that provide intimate conformal contact from the high local pressures generated by the cold spray system 20.

Initially, a preliminary design of a near net shape component is proposed (Step 202). That is, models are developed to optimize the near net shape component design to be manufactured with cold spray additive manufacturing.

A substrate 44 (FIG. 3) is manufactured to provide, for example, a mandrel-like shape to initiate the cold spray process. The substrate may, for example, provide an outer diameter that becomes a gear shaft inner diameter of the near net shape component (Step 204).

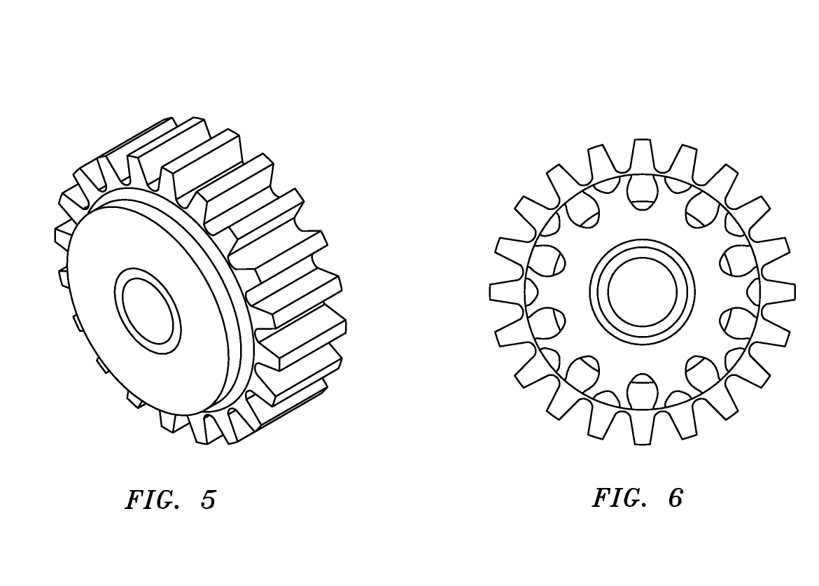

The near net shape component design may then be optimized with, for example, OptiStruct Topology optimization software manufactured by Altair Engineering, Inc. The optimization constraints may include a 25% increase in the material mechanical properties, increased surface resistance to fatigue and wear with a stronger material such as tool steel, reduce component weight without stress state increase and enhanced performance. One example output of the optimization analysis is to reduce weight of a near net shape gear (RELATED ART; FIG. 5) (Step 206; FIG. 6). Another optimization analysis may be directed to a low cost gear. A third optimization analysis may be directed to increase the fatigue strength of the near net shape component.

After near net shape component design optimization, finite element modeling of the cold spray process (modeling of the multiple splats deposition) may be used to optimize the process parameters such as powdered material initial temperature, critical velocity, and powder size to facilitate cold spraying at a temperature below the melting point of the metal materials. The desired velocity is greater than the critical velocity necessary to achieve a successful deposition in their solid state.

Models may then be used to identify the optimum powder deposition path for each material to insure proper bonding of the particles (Step 208). This model may also be used to support the selection of nozzle 30 geometry to increase the efficiency of the deposition process. The near net shape is then produced via the cold spray process on the substrate (Step 210).

The heat treatment of the near net shape may also be simulated with finite element analysis to define the heating temperature and cooling rate for the selected carbon steel and tool steel material properties (Step 212).

The produced near net shape component is then heat treated to achieve the required properties (Step 214). No carburization heat treatment cycle is required since tool steel material is utilized at the tooth surface.

The core substrate 44 is then melted and removed (Step 216). That is, the substrate 44 upon which the cold spray additive manufacturing is initiated is removed.

Optimum machining parameters and cutter paths are then identified to generate the final tooth profile (Step 218). Because the surface hardness after heat treatment is greater than 60 Rc in the disclosed non-limiting embodiment, the final process is to use hard turning technologies and ceramic or cubic boron nitride tools to machine the gear teeth to the final profile. The shaft 46 (FIG. 3) may then be machined to final dimensions (Step 220).

Following this methodology, a cold spray additive manufacturing component has shown an increase in both ultimate tensile strength and yield by approximately 20%.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should also be understood that although a particular component arrangement is disclosed in the illustrated embodiment, other arrangements will benefit herefrom.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

Although particular step sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be understood that within the scope of the appended claims, the disclosure may be practiced other than as specifically described. For that reason the appended claims should be studied to determine true scope and content.

What is claimed is:

1. An additive manufacturing system comprising:
a cold spray system operable to accelerate a powdered material.

2. The system as recited in claim 1, wherein said powdered material includes a ductile material.

3. The system as recited in claim 2, wherein said powdered material is a copper alloy.

4. The system as recited in claim 2, wherein said powdered material is an aluminum alloy.

5. The system as recited in claim 1, wherein said powdered material includes one or more of a titanium alloy, magnesium alloy, cobalt alloy, carbide, nitride and oxide.

6. The system as recited in claim 1, wherein said powdered material are particles of approximately 1-100 μm.

7. The system as recited in claim 1, wherein said cold spray system utilizes a carrier gas at a velocity of approximately 300-1500 m/s.

8. The system as recited in claim 1, wherein said cold spray system utilizes a carrier gas, said carrier gas is an inert gas.

9. The system as recited in claim 1, wherein said cold spray system utilizes a carrier gas, said carrier gas is a semi-inert gas.

10. The system as recited in claim 1, wherein said cold spray system utilizes a carrier gas, said carrier gas is non-oxidizing to powdered material particles.

11. The system as recited in claim 1, wherein said cold spray system utilizes a carrier gas, said carrier gas is non-oxidizing to powdered material particles.

12. The system as recited in claim 1, wherein said cold spray system utilizes a carrier gas at temperatures of approximately 1470 F (800 C).

13. The system as recited in claim 1, wherein said cold spray system utilizes a carrier gas, said carrier gas is Helium.

14. The system as recited in claim 1, wherein said cold spray system utilizes a carrier gas, said carrier gas is Nitrogen.

15. The system as recited in claim 1, wherein said cold spray system utilizes a carrier gas, said carrier gas is Krypton.

16. A method of additive manufacturing comprising:
cold spraying a powdered material to accelerate and plastically deform the powdered material to form a near net shape component.

17. The method as recited in claim 16, further comprising cold spraying the powdered material onto a substrate.

18. The method as recited in claim 16, further comprising generating high strain rate plasticity.

19. The method as recited in claim 16, further comprising cold spraying the powdered material via a cold spray system.

20. The method as recited in claim 16, further comprising cold spraying a multiple of powdered materials to form the near net shape component.
